(19) United States
(12) Patent Application Publication
(10) Pub. No.: US 2012/0179508 A1
(43) Pub. Date: Jul. 12, 2012

(54) TOOL FOR CONTROLLING COMPLEX SYSTEMS

(75) Inventor: Alfa Merethe Sefland, Bergen (NO)

(73) Assignee: THEANO AS, Bergen (NO)

(21) Appl. No.: 13/252,518

(22) Filed: Oct. 4, 2011

(30) Foreign Application Priority Data
Jan. 12, 2011 (NO) 20110043
May 6, 2011 (GB) 1107579.3

(51) Int. Cl. G06Q 10/00

(52) U.S. Cl. 705/7.27

(57) ABSTRACT

Tools/devices for controlling one or more complex processes of one or more technical systems are implemented using one or more software products stored on machine-readable storage media executing on computing hardware. The complex processes optionally pertain to one or more industries and/or industrial processes. The tool/device collects data describing relationships between stakeholders involved with the complex processes and/or parameters influencing performance of the complex processes, and data describing stakeholder relationships to the complex processes and/or mutual relationships between the complex processes. The tool/device analyzes parameters derived from the data which describe the stakeholders and the complex processes to identify a degree of interest of the stakeholders and a relevance of the stakeholders to the complex processes for improving implementation and/or effectiveness of the complex processes, and/or to identify a degree of conflict between the complex processes for improving implementation and/or effectiveness of the complex processes.

### CROSS-REFERENCE TO RELATED APPLICATIONS

This application claims priority from Norwegian Application No. 20110043, filed on Jan. 12, 2011, and from United Kingdom Application No. 1107579.3 filed on May 6, 2011. The content of both of these applications is incorporated herein by reference.

### FIELD OF THE INVENTION

The present invention relates to tools for controlling complex systems, for example for controlling complex technical systems each comprising a plurality of processes which mutually interact and which mutually compete for resources within a finitely-bounded resource field. One or more of the processes competing for resources can be represented by different groups or stakeholders, and the system optionally functions by way of the processes involving selection, coordination and direction of the processes. The selection, coordination and direction is beneficially automated and under computer control, although human intervention and judgment can be optionally employed. Moreover, the present invention is concerned with methods of utilizing aforesaid tools. Furthermore, the invention is concerned with software products stored on machine-readable data carriers, wherein the software products are susceptible to being executed on computing hardware for implementing methods of using the tools. Additionally, the present invention relates to a tool/device for enabling stakeholder engagement by employing a method embodying a structured process having associated parameters, for example key performance indicators (KPI), for ensuring technical execution within time and budget constraints. The tool/device is industrially applicable for improving performance and output from industrial manufacturing facilities and associated projects.

### BACKGROUND TO THE INVENTION

Major projects have been implemented over the centuries, for example the construction of famous Gothic cathedrals in central Europe, the construction of defense castles of the Middle Ages, the Apollo space missions, infrastructure such as motorways and railway networks, the Mongstad-project for Carbon Dioxide capture and storage, cement works and so on. Such projects require the use of material resources and coordination between different participating parties, as well as the use of material resources when the major projects are eventually brought into operation. Moreover, it is important that large projects are implemented within their budget limits, within agreed time plans and/or temporal production schedules and to an acceptable technical standard or production quality control target. In later times, computers and similar IT resources have been an important factor when large expensive activities are set in motion, and eventually brought into technical operation. Often, many stakeholders and/or key technical processes are involved which/who have a potential conflict of interest and/or their own agenda in focus instead of having the success of the project in focus within agreed cost limits and time scales.

In a published US patent application no. US2009/0313173A1 (Inderpal Singh), there is described a software-based dynamic negotiation system which is operable to assist a user or team of personnel through a preparatory process with aim to prepare the user or team of personnel to undertake negotiations, for example in relation to implementing a large construction project. The system functions by asking about key interested parties, namely “stakeholders”, and preparing parallel and coordinated analysis for understanding given members of the group of stakeholders, and evaluating specific aspects and options. The system also formulates test situations for testing the evaluations and thereby enables enhanced understanding of various different options, and suggests possibilities that have not been evaluated for using to provide a plurality of equivalent simultaneous options. The system provides a framework for effective negotiations, which makes possible negotiating strategies pursuant to best practice within an organization, on account of all personnel implementing the same preparatory process and employing mutual similar strategies.

In practice, it has become evident that the aforementioned known tool and system can be a major help during a preparatory period, but are not well adapted to be of assistance when a given project has commenced and perhaps later faces difficulties during execution. Computer-automated control systems have been the subject of granted patent rights for many decades and represents patentable subject matter. The present invention is to be construed in a similar manner. However, a degree of human intervention in computer-automated control systems is permitted without rendering the computer-automated control systems unpatentable subject matter.

### SUMMARY OF THE INVENTION

An aim of the present invention is to develop a database-supported tool based on a method of representing information, data and/or parameters regarding one or more relevant technical processes of systems and/or one or more interested parties, for example “stakeholders”, in technical projects and/or technical systems, for example where multiple technical processes mutually interact during operation of a technical system and/or where a commercial enterprise has several projects and these are organized in a program, or portfolio of processes, and where the tool is to be integrated with semantic searches, known tools and systems in an improved manner.

A further aim of the present invention is to provide a method, namely a process, which is capable of limiting information, namely filtering information, to that which is operatively relevant and to exclude information of abstract academic interest.

A further aim of the invention is to provide a method which provides as a technical measurement output key performance indicators (KPI) from various sensory data, automatic data input and/or, manual data input, pertinent to technical projects and industry, for example for continuous industrial processes.

A further aim of the present invention is to provide a tool, namely Stakeholder Risk Index tool and a Stakeholder Globe tool, which is adapted to reduce risk and to improve decision-making processes for at least one of commercial enterprises and technical systems, for example with regard to Applicant's construction projects by way of a unique, quality-assured process for planning, analyzing and visualizing which ensures an involvement of necessary and correct interested parties, namely stakeholders.

According to a first aspect of the present invention, there is provided a tool as defined in appended claim 1: there is provided a tool for controlling one or more complex processes of one or more technical systems, wherein the tool is implemented using one or more software products stored on machine readable data storage media which are operable to be executed upon computing hardware, characterized in that

the tool is operable to collect in data which describes relationships (F) between one or more stakeholders involved with the one or more complex processes and/or parameters influencing performance of the one or more complex processes, and data which describes relationships (P) of the stakeholders to the one or more complex processes and/or mutual relationships (P) between the one or more complex processes, and that
the tool is operable to analyze parameters (F, P) derived from the data which describe the stakeholders and the one or more complex processes to identify a degree of interest of the stakeholders and a relevance of the stakeholders to the one or more complex processes for improving implementation and/or effectiveness of the one or more complex processes, and/or to identify a degree of conflict between the one or more complex processes for improving implementation and/or effectiveness of the one or more complex processes.

The present invention is of advantage in that it provides to project managers and decision-makers a method and associated generated key performance indicator (KPI) and a corresponding tool which are capable of improving and quality assuring decision processes by way of structuring information in respect of commercially interested parties in projects, namely stakeholders, and their role in different projects and their mutual relationships, together with documenting decisions and distributing information internally within organizations involved in the projects, as well as providing for automated control of projects.

The method of the invention is optionally capable of generating key performance indicators (KPI), which are useful in technical projects and industry as measurands for feedback control purposes. The KPI is reproducible in all projects and gives users the benefit of tracing and comparing effect across projects and industries. The KPI can be generated, for example, by automated sensory input, for example from sensors installed along a production line, and outputs of the method can be used directly to control execution of industrial projects and processes.

In the foregoing, “interested parties” is to be optionally understood to mean “stakeholders”.

Optionally, the tool is implemented as one or more software products, which can be executed on computing hardware. More optionally, the tool is adapted to structure, to prioritize and to filter interested parties which are stakeholders in a project (X) controlled by the computing hardware. Computer-based control for technical systems has been the subject of patents for many years and does not constitute excluded subject matter.

More optionally, the tool is operable:
(a) to filter the interested parties as stakeholders into groups identified by color and corresponding properties, for example yellow for “undecided”, green for “positive”, red for “oppose”;
(b) to present one or more strategies with one or more corresponding decisions, and thereafter to analyze the decisions;
(c) to ensure a quality of the analysis by involving a plurality of relevant personnel and project participants; and
(d) to implement the strategies after quality assurance to control implementation of the project (x).

More optionally, the tool is implemented such that the analysis generates a Stakeholder Risk Index for representing risks associated with stages of the project (X), and also generates a position map and a negotiating map, which are accessible to leaders at various stages during implementation of the project (X). The negotiating map is indicative of where and when negotiating activities are required, and the position map, also known as a power map, is indicative of when and in what areas the participating parties have power to influence progression of the project (X).

According to a second aspect of the invention, there is provided a method of controlling one or more complex processes of one or more technical systems, using a tool implemented using one or more software products stored on machine readable data storage media which are operable to be executed upon computing hardware, characterized in that the method includes:
(a) using the tool to collect in data which describes relationships (F) between one or more stakeholders involved with the one or more complex processes and/or parameters influencing performance of the one or more complex processes, and data which describes relationships (P) of the stakeholders to the one or more complex processes and/or mutual relationships (P) between the one or more complex processes;
(b) using the tool to analyze parameters (F, P) derived from the data which describe the stakeholders and the one or more complex processes to identify a degree of interest of the stakeholders and a relevance of the stakeholders to the one or more complex processes for improving implementation and/or effectiveness of the one or more complex processes, and/or to identify a degree of conflict between the one or more complex processes for improving implementation and/or effectiveness of the one or more complex processes.

According to a third aspect of the present invention, there is provided a software product stored on data storage media, characterized in that the software product is executable upon computing hardware for implementing tools and methods pursuant to the first and/or second aspect of the invention.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the diagrams, wherein:

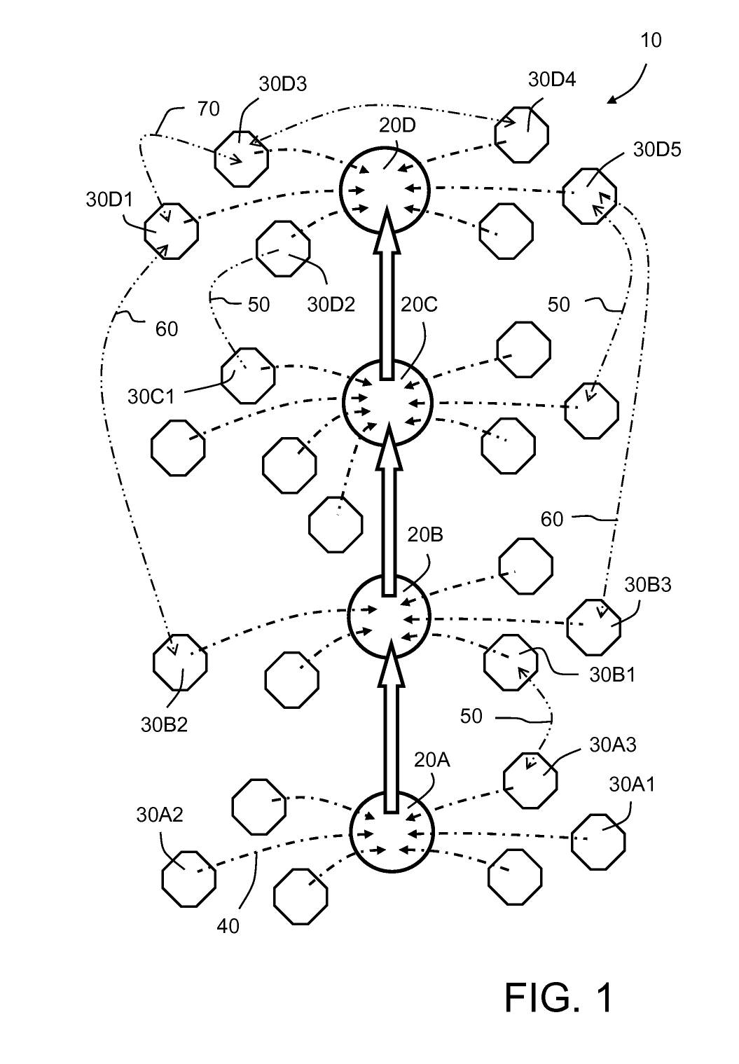

FIG. 1 is a graphical representation of a complex technical process, which a tool, namely an embodiment of the present invention, is adapted to control and/or to plan the process and its stakeholders;

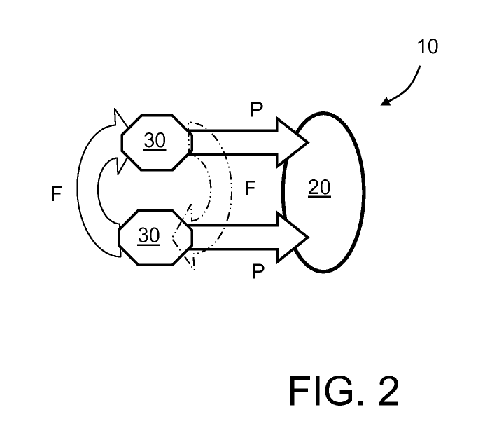

FIG. 2 is an alternative illustration of a complex technical process, which a tool, namely an embodiment of the present invention, is adapted to control and/or to plan the process and its stakeholders;

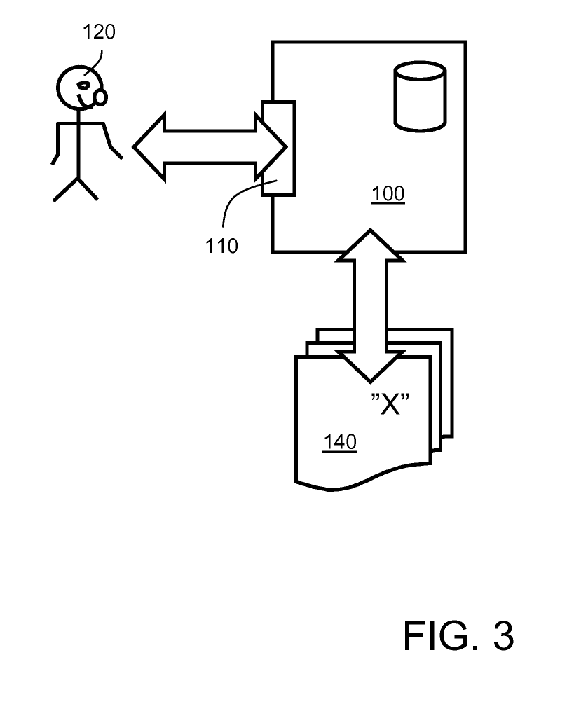

FIG. 3 is an illustration of a computer system adapted to implement the tool adapted to control the complex process as shown in FIG. 1;

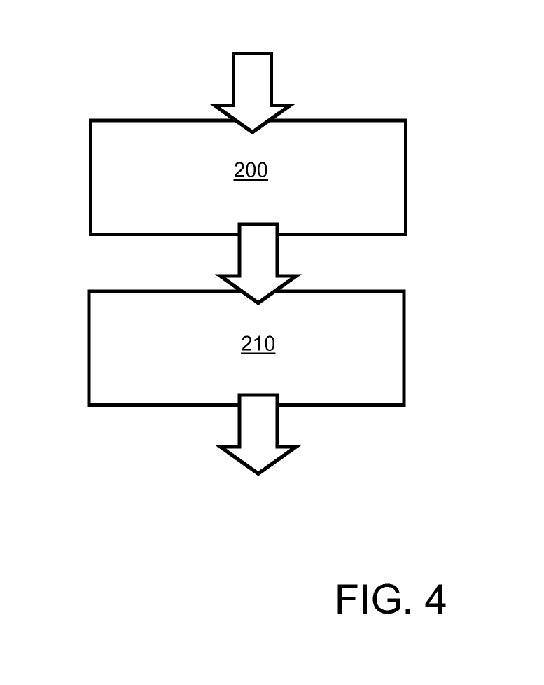

FIG. 4 is an illustration of software steps of a method utilized by the tool;

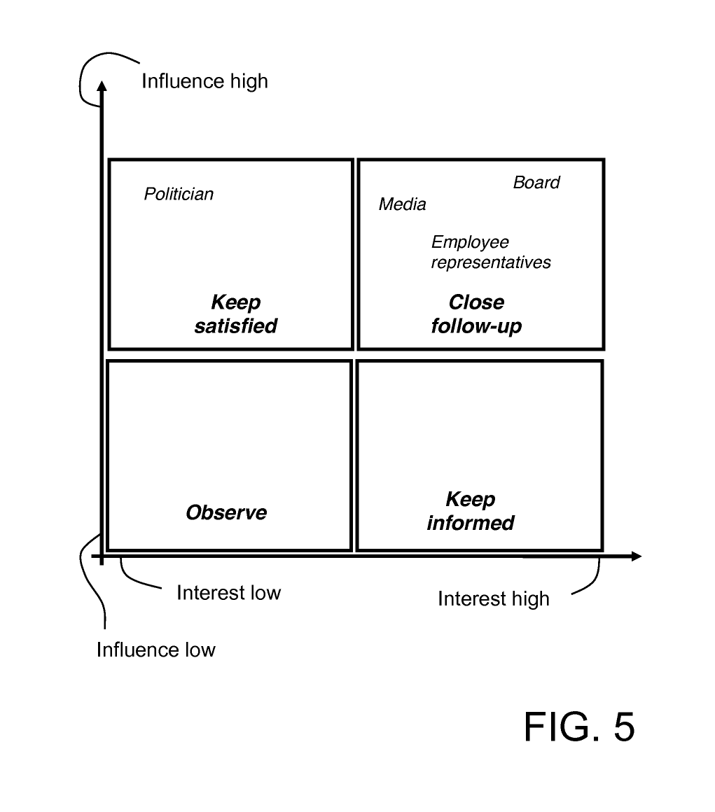

FIG. 5 is an illustration of a power map, namely an interested party position map, utilized by the tool pursuant to the present invention; and

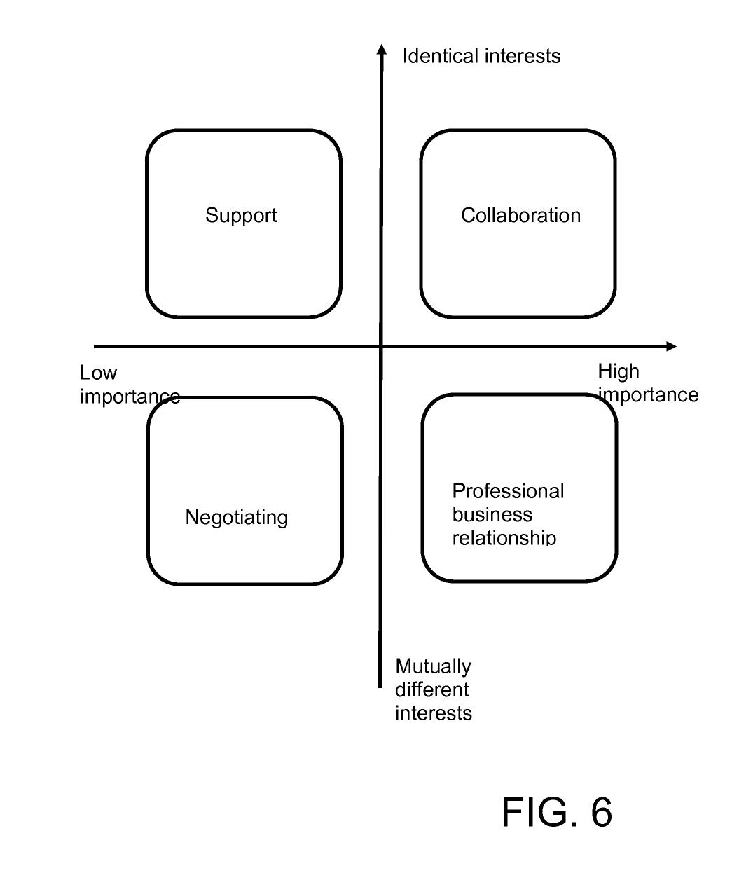

FIG. 6 is an illustration of a negotiating map utilized by the tool pursuant to the present invention.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In FIG. 1, there is shown a graphical representation of a complex technical process indicated generally by 10. One or more such processes 10 are implemented in one or more technical systems for purposes of implementing the present invention, for example in a manufacturing facility, an airport, a harbor, a renewable energy facility, a coal-fired power station, a Thorium LFTR nuclear power station or similar. The process 10 includes a plurality of stages 20, for example stages 20A, 20B, 20C, 20D, which are planned to be implemented in a time sequence, namely the first stage 20A, thereafter the second stage 20B, thereafter the third stage 20C, and finally the fourth stage 20D; for example, the stages 20 are milestones in a renewable energy system installation project or a MAGLEV railway project, or refueling and subsequent power generating stages for a solid-fuel Thorium nuclear reactor cycle wherein choice of fuel supplier in an earlier stage can influence waste disposal issues at a later stage, including cost aspects. Each stage 20 involves one or more stakeholders 30, namely one or more affected stakeholders, for example the stage 20A has associated therewith an stakeholder 30A1, and the stage 20C has associated therewith an stakeholder 30C1, and so forth. However, various mutually interactions arise between the stages 20A, 20B, 20C, 20D as will be elucidated in greater detail later.

Each stakeholder 30 has a relevance or engagement, which is represented by links 40; the relevance or engagement is susceptible to being described via one or more parameters P. The one or more parameters P are also optionally employed to describe mutual interaction or conflict of interest between the stages 20A, 20B, 20C, 20D. The stakeholders 30 also have potential relevance or engagement therebetween (F), for example they have a common-shared owner or are a part of a single consortium. Alternatively, there can arise a situation wherein some of the stakeholders 30 are direct competitors and risk using the project and the process 10 as an arena for fighting one another which has a detrimental effect on implementation of the process 10, for example represented by 50 between two neighboring stages 20 in the process 10, or represented by 60 between two stages 20 which are temporally more distant. As a further alternative, the same interested party 30 can be involved in a given stage 20 and can have conflicting views with its engagement in another stage 20 in the process 10, for example concerning access the specialist equipment which the given interested party 30 owns, for example a crane ship for installation of blades of wind turbines or rotors thereof.

It is standard known practice to do an evaluation of stakeholders 30 from earlier human experience, for example in connection with properties from earlier implemented projects, for example satisfactory performance, late performance, poor quality performance, too costly performance and/or poor performance resulting in secondary complications. Poor performance resulting is secondary complications can, for example, relate to design of a component part for a renewable-energy wind turbine, wherein an unsuitable choice of component materials results in corrosion problems when deployed in a corrosive offshore environment. The process 10 is of advantage when implemented in a tool pursuant to the present invention in that definitions of parameters describing the relevances and the relationships are used to automate and systematize the process 10 and thereby provide better control of complex processes associated with one or more technical systems. Optionally, the tool is also employed with benefit to address conflicts of interest between stages in the process 10; conflicts of interest can, for example, pertain to choice of nuclear fuel versus fuel waste disposal issues later after the nuclear fuel has been several years within a nuclear reactor. As shown in FIG. 2, the stakeholders 30 mutually influence one another as represented by parameters F, and also affect the stages 20 depending on roles that the stakeholders 30 exercise when implementing the stages 20. The stages 20 relate to a technical system which has a technical effect, for example a configuration of oil wells, and wind turbine park, an atomic power reactor, and so forth. The present invention concerns a tool for use by project managers and decision-makers which can improve and quality-assure decision processes by way of structuring information regarding businesses of the stakeholders, for example with regard to their role in different projects and their established relationships, together with documenting decisions and to distribute information internally during execution of a complex project. The tool is optionally employed for daily real-time control of technical systems and represents subject matter which is not excluded from patentability; in comparison, reference is made to granted patent rights pertaining to a patent family including an international PCT patent application no. PCT/NO2008/00046 (Epsis AS), for example granted Norwegian patent no. NO 327319 wherein Patentstyret practice is harmonized to that of the European Patent Office (EPO).

There is not to be found, from Applicant's experience, a method-based tool which in a simple manner is capable of collating together relevant information regarding technical processes in projects, and/or stakeholders in projects, and/or processes and/or portfolios and/or programs and simultaneously integrate these by way of information network searches (for example Internet searches/Linked Open Data) and known systems and tools which many people are able to use, for example Microsoft Windows (“Windows” is a trademark of Microsoft Corp.), in a manner as employed in the present invention. Embodiments of the invention have as one of their functions to filter relevant information regarding stakeholders per project, process, portfolio and so forth, such that a business responsible for the project can keep an overall watch, trace and compare effects across projects and can identify concrete decision by way of coupling:
(i) parameters which describe information relating to a given project X, for example parameters which describe the aim and ambition, and a process which could be considered for directing the project X, for example parameters which describe technical aspects of one or more technical processes of the project X, for example process throughput, processes concentration, process temperature, process ingredient ratios and so forth;
(ii) parameters which describe information about stakeholders, for example parameters which describe information regarding interested parties (stakeholders) and/or technical interaction between technical processes, wherein the parameters define one or more of identity, roles in the project X, relationship to the project X, established relationships (for example, earlier established relationships) in respect of the project X, conflicts of interest to the project X (for example, in relation to other participants in one or more stages 20 of the project X); and
(iii) parameters that describe one or more agents which are integrated in solutions for the project X, for example which are able to provide relevant database searches, for example Internet searches, associated with aforementioned identity and/or roles. The one or more agents are optionally of technical nature and pertain to real physical variables which are to be managed or controlled.

Output measurands and key performance indicators (KPI) can be used for controlling operation of facilities, for example by way of management structure and/or directly by automatic arrangements, and thereby provide a technical benefit, for example enhanced energy efficiency, less use of manufacturing materials, faster manufacturing output, faster deployment of new technical facilities.

The present invention provides a solution which includes a method which is operable to structure, to prioritize and to filter parameters which represents stakeholders in the project X and forms a basis for the tool pursuant to the invention. The tool is based on one or more software products which are susceptible of being executed by a computer 100 shown in FIG. 3. The computer 100 has an input 110 for communicating to a user 120, and has an output for coupling to participants 30 in a project X, 140 which is implemented via one or more stages 20. The tool uses an architecture which is akin to mind mapping, but the tool is differentiated in that this method is strongly structured and bound to specific parameters, for example parameters describing real physical variables of a systems as measured using technical sensors or transducers, which are used to select stakeholders in defined projects and/or processes and/or portfolios and/or programs; it is thereby possible to sort and to prioritize the interested parties, namely the stakeholders 30.

As an example, the tool beneficially uses the following prioritizing of the stakeholders 30 in a three-way categorizing:
(a) “yellow” is used to define undecided, unsafe, potentially negatively affected parties, for example where there is a technical resource conflict in respect of a physical variable; these stakeholders 30 will always be considered “Pri1” choice group and uppermost on the list used by the tool;
(b) “green” is used to define positive, not negatively affected parties; these stakeholders will always be given a following measure “keep informed and mobilize depending upon need” during the process 10, namely the project “X”;
(c) “red” is used to define opposers, who are negatively affected, will be mobilized in opposition; these stakeholders 30 ought to be addressed with “Instant Rebuttal”, measures which quickly meet arguments with facts, but few other actions.

Such a step to sort and to prioritize the stakeholders 30 enables a choice of most suitable stakeholders for engaging when implementing stages the project X.

The tool uses a “cloud-based” process to map out the stakeholders, strategy and to analyze decisions, with a extensive interface to known commercial systems and mobile platforms which render it possible to filter different “stakeholder interest” in relation to the project's and commercial interests, and to sort out priorities from areas/issues where there is found from the analysis to be a risk of conflicts of interest arising. As aforementioned, “stakeholder interest” is optionally construed to represent conflicts of interest between processes and/or stages in an automated technical control system. Moreover, the tool is adapted to assure quality in the analysis, to implement internal determinations/judgments and information flows during implementing tasks by way of:
(i) involving several, relevant co-workers and/or project participants in mapping out and analyzing stages 20 of the project X; and
(ii) creating opportunities for the user 120 to work with mapping and analysis in real time, for example in a project workplace and during meetings for implementing the project X.

For increased quality assurance and realizing benefits when planning and implementation, the tool is operable to steer the user 120 through a course of activity wherein the stakeholders 30 are categorized and prioritized to respect of defined criteria such that the following are addressed and visualized:
(a) an issue of whether or not an enterprise responsible for the project X has considered and addressed all relevant stakeholders 30;

Stakeholder Risk Index is used in the tool which provides values for:
a composition, namely criteria in the form of parameters which ensure that all relevant main groups are included in the analysis;
an uncertainty, namely criteria in the form of parameters which describe a number of internal participants in the analysis, namely for ensuring an increased objectivity to the analysis;
a strain on the stakeholders 30, namely parameters which define criteria which provide a degree/extent of expected influence and/or strain on the stakeholders 30;
an influence arising from the stakeholders 30, namely parameters which define criteria which provide an expected effect and/or mobilization of the stakeholders 30;
a conflict of interest between the stakeholders 30 and/or stages 20 of the project X, namely parameters which define criteria which determine a degree of expected conflict of interests between one or more enterprises and one or more stakeholders 30;
(b) which role the stakeholders 30 have in the project X, namely to categorize via parameters with regard to defined roles and/or are “open” for enterprises which are stakeholders to define;
(c) which role the stakeholders 30 have in other projects, for example earlier, on-going and/or future projects, namely to categorize with regard to defined roles and/or marked as “open” for enterprises as stakeholders 30 to define;
(d) which mutual relationships to the stakeholders 30 in respect of other stakeholders in the project X and/or in respect of other projects and processes in enterprises, for example:
   to submit into a database accessible to the tool known information; and
   to fetch in information from other external net-based (for example Internet-based) sources by help of an agent, for example a partner and/or or a semantic search;
(e) which other relevant information is known for use when prioritizing the stakeholders 30, namely:
   to submit into a database accessible to the tool known information for the tool to use;
   to gather information from other external net-based sources (for example Internet sources) via assistance from an agent, for example by way of help from a partner and/or by way of a semantic search;
(f) who are the most important stakeholders 30, namely:
   to prepare and to use a negotiating map, namely to categorize with regard to criteria for potential collaboration or conflict; and
   to prepare and to use an influence map, namely to categorize with regard to criteria for expected engagement and potential influence;
(g) when are the stakeholders 30 most important, namely:
   to prepare and the use a process map, to categorize with regard to milestones in the project's implementation plan, for example in association with a calendar; and
   to plan and to document initiatives, for example presentations and similar with linking to correspondence and/or other presentations.

As aforementioned, the tool is implemented via one or more software products executable on a computer 100. The tool employs software steps which constitute a part of the method implemented via use of the one or more software products. The software steps of the tool are shown in FIG. 4 and include a first software step 200 and thereafter a second software step 210.

Software step 1: The first software step 200 is concerned with establishing the project X, wherein the user 120 inputs first background data which includes one or more of:
(a) one or more aims for the project X;
(b) one or more expected benefits from implementing the project X, for example effective project implementation, market development and technical product development;
(c) organizing, for example to declare whether or not the project X belongs to a programme, portfolio or process;
(d) a calendar or time plan, for example starting up, milestones, conclusion, for example coupled to or loaded up from Outlook, Excel or similar standard software products;
(e) project groups, for example project owners, project leaders, project groups, for example loaded up from Excel or Outlook or similar;
(f) information distribution, for example to invite others to participate in work for the project X, for example to send one or more invitations; the aim therewith is to reduce uncertainty and/or to increase objectivity in mapping and analysis, which provides benefits with regard to actual participants and not just invited participants:
   information concerning whether or not the number of internal participants in preparing maps and/or analysis is less than 2; in such case, the tool is operable to route to the Stakeholder Risk Index to define uncertainty, namely “red” as aforementioned;
   information concerning whether or not the number of internal participants in preparing maps are the same as or greater than 3, or less than of the same as 4; in such case, the tool is operable to route to the Stakeholder Risk Index to define uncertainty “yellow” as aforementioned;
   information concerning whether or not the number of internal participants in preparing maps and/or analyzing is greater than or the same as 5; in such case, the tool is operable to route to the Stakeholder Risk Index to define uncertainty “green” as aforementioned;
(g) known stakeholders 30, for example the tool is operable to allow input regarding other known stakeholders 30, for example from a same file which was earlier open or from other financial systems and so forth.

The tool functions to implement a supporting principle of sorting and prioritizing the stakeholders 30 in the aforementioned three-way categorization, namely:
“yellow” defines an undecided, uncertain evaluation and could be negatively affected (strain); as aforementioned, these stakeholders 30 will always be “Pri1” target group and uppermost on the initiative utilized by the tool;
“green” defines a positive and/or unaffected evaluation, namely to indicate the stakeholders 30 which will always be given the following attribute “keep informed and mobilize after need”;
“red” defines an opposer, namely is negatively affected and could mobilize against, to identify the stakeholders 30 who ought to be handled with “Instant Rebuttal” and/or measures which meet arguments with facts, but few other active initiatives.

Software step 2: The second software step 210 is concerned with describing data relating to project stakeholders into the tool. When corresponding information is required to describe new stakeholders, the tool requires information regarding:
(a) people, groups and/or organizations, for example:
   to describe the identity, for example fundamental personal details such as project code wherein the identity is generated as a customer number or reference number;
   to describe roles in the project X or corresponding processes, programs, portfolios, for example information regarding projects, project participants, external decisions, competitors, activists and similar;
(b) types of stakeholders, for example principal groups and sub-groups; a purpose therewith is to sort the stakeholders with respect to Stakeholder Risk Index and to ensure that all types of stakeholders 30 are taken into consideration. Main groups are beneficially defined as one or more of:

| | |
|---|---|
| (i) owners; | (ii) financial community; |
| (iii) local community; | (iv) activist groups; |
| (v) customers; | (vi) consumers' advocate groups; |
| (vii) trade unions or similar; | (viii) employees; |
| (ix) trade associations; | (x) competitors; |
| (xi) suppliers; | (xii) Government; |
| (xiii) political groups; | (xiv) media. |

The tool also seeks to determine:
if the number of main groups which are described are below 50%, i.e. less than or the same as 7, that the tool is operable to route to the Stakeholder Risk Index for a designation “red;

if the number of main groups which are described covers between 51% and 85%, i.e. greater than or the same as 8, alternatively is less than or the same as 12, that the tool is operable to route to the Stakeholder Risk Index for a designation “yellow”;
if the number of main groups is between 86% and 100%, i.e. larger than or the same as 13, that the tool is operable to route to the Stakeholder Risk Index for a designation “green”.

Beneficially, in an event that a project manager or top management envisage that some main groups designated as “not relevant for the present project X”, this is marked out, for example with a cross-like marking, basis given and is routed to a concluding report for document the project X. The Stakeholder Risk Index is adjusted with regard to some main groups are excluded from the analysis;
(c) the expected attitude to project X, namely with regard to sorting critical stakeholders 30, such that:
   if the expected attitude is positive; the tool is operable to route corresponding information to the Stakeholder Risk Index and apply a designation of low conflict, namely “green”;
   if the expected attitude is neutral, the tool is operable to route corresponding information to the position map, for example a power map, and to apply a designation of positive interest, namely “green”;
   if the expected attitude is neutral, the tool is operable to route corresponding information to the Stakeholder Risk Index to apply a designation of potential conflict, namely “yellow”;
   if the expected attitude is neutral, the tool is operable to route corresponding information to the position map, namely power map, and to apply a designation of interest, namely “yellow”;
   if the expected attitude is negative, the tool is operable to route corresponding information to the Stake Holder Index, to apply a designation of conflict, namely “red”;
   if the expected attitude is negative, the tool is operable to route corresponding information to the position map, namely power map, and to apply a designation of interest, namely “red”, for example when a possibility to influence is greater than or the same as 3;
(d) strain from the project X on the stakeholders 30; the purpose of this is to sort and/or to prioritize heavily burdened/affected stakeholders 30. Categories of such strain are beneficially defined as low/small, neutral and high/large. The tool is operable to implement the following in such case:
   if the strain on a stakeholder in a category “positive” is determined high/large, the tool is operable to route corresponding information to the Stakeholder Risk Index for indicating strain, namely “yellow”;
   if the strain on a stakeholder in a category “positive” is determined high/large, the tool is operable to route corresponding information to the negotiating map, namely for support;
   if the strain on a stakeholder in a category “positive” is determined low/small or neutral, the tool is operable to route corresponding information to the Stakeholder Risk Index to indicate low strain, namely “green”;
   if the strain on a stakeholder in a category “positive” is determined low/small or neutral, the tool is operable to route corresponding information to the negotiating map, namely to indicate cooperation;
   if the strain on a stakeholder in a category “negative” is determined high/large, the tool is operable to route information to the Stakeholder Risk Index to indicate “conflict”, namely “red”;
   if the strain on a stakeholder in a category “negative” is determined high/large, the tool is operable to route information to the negotiating map, namely for professional handling, i.e. commercial negotiation;
   if the strain on a stakeholder in a category “negative” is determined low/small or neutral, the tool is operable to route corresponding information to the Stakeholder Risk Index to indicate conflict, namely “yellow”;
   if the strain on a stakeholder in a category “negative” is determined low/small or neutral, the tool is operable to route corresponding information to the negotiating map, namely for negotiation;
(e) an ability to influence the project X is evaluated by the tool, such that:
   if the ability to influence is high, in a scale from 1 to 10, namely larger than or the same as 7, the tool is operable to route corresponding information to the position map, namely to the power map, namely to designate “influence”, and place according to value;
   if the ability to influence is neutral, namely large than or the same as 3, and less than or the same as 6, the tool is operable to route corresponding information to the position map, namely to the power map, namely to designate “influence”, and place according to value;
   if the ability to influence is undecided, the tool is operable to route corresponding information to the position map, namely to the power map, to an “OBS” list thereof (namely is marked for attention);
   if the ability to influence is low, namely lower than or the same as 2, the tool is operable of route corresponding information concerning “evaluated, not relevant to the project X”;
   if the ability to influence is low, namely less than or the same as 2, the tool is operable to route corresponding information “evaluated, not relevant to the project X” with an extra additional information to indicate that the ability to influence in the project X is not to be considered further in the analysis implemented by the tool.

The tool optionally includes a “panic button” for use in an event that the process controlled by the tool comes out of control, for example with corresponding technical and/or financial risk. The tool functions to seek for combinations of Stakeholder Risk Index which deviate from a normal average in the aforesaid database, namely to provide visibility regarding possible problem areas in the project X, and to give other error indications such as lack of information and/or contradictory information. Optionally, the tool is operable to implement simulations, for example:
(i) to simulate whether or not the identity I1 executes the activity A in the first stage 20A of the project X; compared with
(ii) to simulate whether or not the identity I2 executes the activity A in the first stage 20A, compared with
(iii) to simulate whether or not the identity I1 executes the activity A in other stages 20B, 20C, 20D of the project X.

In FIG. 5, there is shown an example of the aforementioned position map, namely power map, employed by the tool which assists the user 120 regarding different types of interested parties, namely stakeholders 30, and their relative power in relation to implementation of the project X. From a horizontal scale (abscissa axis) from left to right, there is shown levels of interest exhibited by the stakeholders, and from a vertical axis (ordinate axis), there is shown a scale from bottom to top which denotes a level of influence of the stakeholders.

In FIG. 6, there is shown an example of the aforementioned negotiating map employed by the tool for prioritizing issues in which the enterprise and its most important stakeholders have interest. The negotiating map is advantageously divided into four zones, namely “support”, “cooperation”, “negotiating” and “professional commercial relationship”. A horizontal scale (abscissa axis) shows low importance on a left-hand side to high importance on a right-hand side, and a vertical axis (ordinate axis) from mutually different interests at a bottom to coincident interests at a top.

It will be appreciated that the tool, for example by way of its various color-defined representations, as well as its filtering and analysis activities allows complex technical projects and processes to be controlled more easily, thereby potentially reducing costs, enhancing safety and efficiency.

The tool is beneficially employed for automated control of technical systems, wherein a degree of human interaction and high-level decision making is involved. For example, the tool is optionally used for commissioning and/or controlling renewable energy systems, advanced Thorium-LFTR nuclear power facilities, airports and such like. Moreover, the tool pursuant to the present invention is optionally combined with contemporary data acquisition systems, for example SCADA data acquisition systems, for obtaining sensor measurements for use in managing the systems, for example in respect of resolving stakeholder problems, wherein the stakeholders are engaged in real-time operation and implementation of the systems.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A tool for controlling one or more complex processes (10) of one or more 5 technical systems, wherein the tool is implemented using one or more software products stored on machine readable data storage media which are operable to be executed upon computing hardware (100), characterized in that
the tool is operable to collect in data which describes relationships (F) between one or more stakeholders (30) involved with the one or more complex processes (10) and/or parameters influencing performance of the one or more complex processes (10), and data which describes relationships (P) of the stakeholders (30) to the one or more complex processes (10) and/or mutual relationships (P) between the one or more complex processes (10), and that
the tool is operable to analyze parameters (F, P) derived from the data which describe the stakeholders and the one or more complex processes (10) to identify a degree of interest of the stakeholders and a relevance of the stakeholders to the one or more complex processes (10) for improving implementation and/or effectiveness of the one or more complex processes (10), and/or to identify a degree of conflict between the one or more complex processes (10) for improving implementation and/or effectiveness of the one or more complex processes (10).

2. The tool as claimed in claim 1, characterized in that the tool is implemented as one or more software products which are executable on a computer (100).

3. The tool as claimed in claim 2, characterized in that the tool is adapted to structure, to prioritize and to filter the stakeholders (30) who are interested parties in a project (X) controlled by the computer (100).

4. The tool as claimed in claim 3, characterized in that the tool is adapted:
(a) to filter said stakeholders into groups designated by color depending upon whether they are undecided, positive or opposed (yellow=“undecided”; green=“positive”; red=“opposed”);
(b) to plan out a strategy with one or more decisions, and thereafter to analyze the one or more decisions;
(c) to ensure quality of analysis by involving a plurality of relevant workers and project participants to review the analysis; and
(d) to implement the strategy after quality assurance to control implementation of the project.

5. The tool as claimed in claim 4, characterized in that the analysis generates a Stakeholder Risk Index for representing risk per stage (20) of the project (X), and also generates a position map and a negotiating map which are accessible for guiding in various stages when implementing the project (X).

6. The tool as claimed in claim 5, characterized in that the Stakeholder Risk Index generated by the analysis at least in part represents conflicts of interest between technical processes which mutually access a resource-limited environment.

7. A method of controlling one or more complex processes (10) of one or more technical systems, the method using a tool implemented using one or more software products stored on machine readable data storage media which are operable to be executed upon computing hardware (100), characterized in that the method includes:
(a) using the tool to collect in data which describes relationships (F) between one or more stakeholders (30) involved with the one or more complex processes (10) and/or parameters influencing performance of the one or more complex processes (10), and data which describes relationships (P) of the stakeholders (30) to the one or more complex processes (10) and/or mutual relationships (P) between the one or more complex processes (10);
(b) using the tool to analyze parameters (F, P) derived from the data which describe the stakeholders (30) and the one or more complex processes (10) to identify a degree of interest of the stakeholders (30) and a relevance of the stakeholders (30) to the one or more complex processes (10) for improving implementation and/or effectiveness of the one or more complex processes (10), and/or to identify a degree of conflict between the one or more complex processes (10) for improving implementation and/or effectiveness of the one or more complex processes (10).

8. A software product stored on machine-readable data storage media, wherein the product is executable on computing hardware (100), characterized in that the software product is adapted to implement a method as claimed in claim 7.
